(19) United States
(12) Patent Application Publication
(10) Pub. No.: US 2020/0226673 A1
(43) Pub. Date: Jul. 16, 2020

(54) METHOD OF RENTING APP

(71) Applicant: Kevin Gabriel Reina, Chicago, IL (US)

(72) Inventor: Kevin Gabriel Reina, Chicago, IL (US)

(21) Appl. No.: 16/248,785

(22) Filed: Jan. 16, 2019

(51) Int. Cl. G06Q 30/06; G06F 16/9537

(52) U.S. Cl. CPC G06Q 30/0645; G06F 16/9537

(57) ABSTRACT

A method of using a software app for smartphones designed to enable consumers, as well as commercial establishments, to rent things—tools, equipment, camping or sporting goods, from snow-blowers to snowmobiles, jet skis to tents, to cars to boats—to one another. The Rayr-Mobile App would bring people or establishments with such things together with those desiring the temporary use of such things, generating income for the one and saving money for the other.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of mobile apps and more specifically relates to a software application for smartphones designed to enable consumers, as well as commercial establishments, to rent things—tools, equipment, camping or sporting goods, from snow-blowers to snowmobiles, jet skis to tents, to cars to boats—to one another.

### 2. Description of the Related Art

Consider, for example, the simple fact that we all need things, from time to time, that we do not possess. We might like to go on a camping trip, but can't afford to outfit ourselves with tents and sleeping bags, cook-stoves and lanterns. We might be visiting the coast, or a lake, and would like to go jet-skiing or boating, but can hardly afford a jet-ski or boat. Or we might like to change the oil in our cars, but lack the ramps and wrenches we need. In each of these cases and thousands of others, what we really need is the use of certain things, tools, or gear—not necessarily the possession of them. We may need to use a pressure-washer, for example, for a specific job—but that hardly justifies our buying one. But what if we could rent almost anything we might need on a limited basis, and do so easily—right over our smartphone, and close to wherever we are? Therefore, a need exists for a service, in the form of a smartphone software application, or app.

Various attempts have been made to solve problems found in mobile apps art. Among these are found in: U.S. Publication No. 2011/0288891 to Sam Zaid; U.S. Publication No. 2015/0105901 to Holly Jean Joshi; and U.S. Publication No. 2014/0278599 to E. Paul Reh. This prior art is representative of rental mobile apps.

None of the above inventions and patents, taken either singly or in combination, is seen to describe the invention as claimed. Ideally, a mobile app to facilitate renting should provide a means for connecting renters and those with things to rent and, yet would operate reliably and be manufactured at a modest expense. Thus, a need exists for a reliable Rayr-Mobile App, software application for smartphones designed to enable consumers, as well as commercial establishments, to rent things—tools, equipment, camping or sporting goods, from snow-blowers to snowmobiles, jet skis to tents, to cars to boats—to one another. The Rayr-Mobile App would bring people or establishments with such things together with those desiring the temporary use of such things, generating income for the one and saving money for the other and to avoid the above-mentioned problems.

### BRIEF SUMMARY OF THE INVENTION

In view of the foregoing disadvantages inherent in the known mobile apps art, the present invention provides a novel Rayr-Mobile App. The general purpose of the present invention, which will be described subsequently in greater detail, is to provide a software application for smartphones designed to enable consumers, as well as commercial establishments, to rent things—tools, equipment, camping or sporting goods, from snow-blowers to snowmobiles, jet skis to tents, to cars to boats—to one another. The Rayr-Mobile App would bring people or establishments with such things together with those desiring the temporary use of such things, generating income for the one and saving money for the other. The features of the invention which are believed to be novel are particularly pointed out and distinctly claimed in the concluding portion of the specification. These and other features, aspects, and advantages of the present invention will become better understood with reference to the following drawings and detailed description.

The present invention holds significant improvements and serves as an app to facilitate the renting of items. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a Rayr-Mobile App, constructed and operative according to the teachings of the present invention.

FIG. 1 is a perspective view illustrating the computer and housing of the Rayr-Mobile App according to an embodiment of the present invention.

FIG. 2 is a perspective view illustrating the splash screen of the Rayr-Mobile App according to an embodiment of the present invention of FIG. 1.

FIG. 3 is a perspective view illustrating a log-in page of the Rayr-Mobile App according to an embodiment of the present invention of FIG. 1.

FIG. 4 is a perspective view illustrating the search page of the Rayr-Mobile App according to an embodiment of the present invention of FIG. 1.

FIG. 5 is a perspective view illustrating a search radius page of the Rayr-Mobile App according to an embodiment of the present invention of FIG. 1.

FIG. 6 is a perspective view illustrating the results page of the Rayr-Mobile App according to an embodiment of the present invention of FIG. 1.

FIG. 7 is a perspective view illustrating a membership page of the Rayr-Mobile App according to an embodiment of the present invention of FIG. 1.

FIG. 8 is a perspective view illustrating an article data base page of the Rayr-Mobile App according to an embodiment of the present invention of FIG. 1.

FIG. 9 is a perspective view illustrating a reservation complete page of the Rayr-Mobile App according to an embodiment of the present invention of FIG. 1.

FIG. 10 is a perspective view illustrating Item in use of the Rayr-Mobile App according to an embodiment of the present invention of FIG. 1.

FIG. 11 is a perspective view illustrating delivery or pick-up page of the Rayr-Mobile App according to an embodiment of the present invention of FIG. 1.

FIG. 12 is a perspective view illustrating rental finish page of the Rayr-Mobile App according to an embodiment of the present invention of FIG. 1.

FIG. 13 is a perspective view illustrating a ratings page of the Rayr-Mobile App according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a mobile app and more particularly to a Rayr-Mobile App, a software application for smartphones designed to enable consumers, as well as commercial establishments, to rent things—tools, equipment, camping or sporting goods, from snow-blowers to snowmobiles, jet skis to tents, to cars to boats—to one another. The Rayr-Mobile App brings people or establishments with such things together with those desiring the temporary use of such things, generating income for the one and saving money for the other.

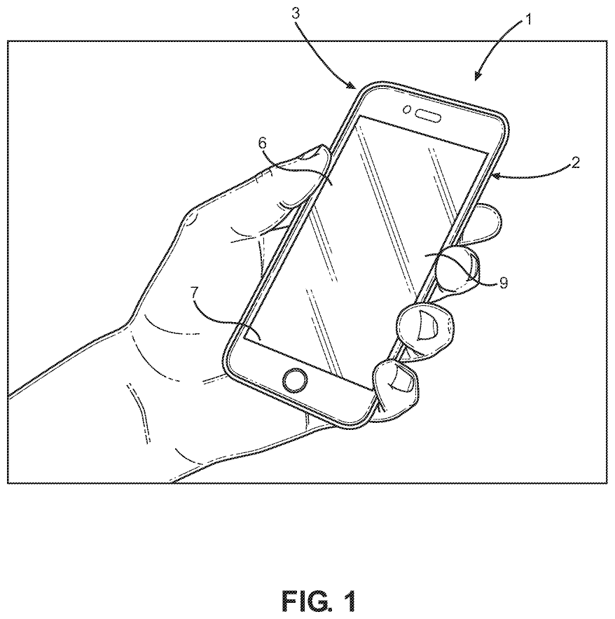

In the Rayr-Mobile App, consumers find a convenient and easy way to obtain articles and equipment that they need for a limited time-period and prefer not to buy; and other consumers find a way to make additional income renting out things they already own. And, because the app is mobile, and local, a consumer can rent desired articles, wherever he or she is. In addition, consumers, as well as business enterprises can make additional income using this app. Clever in conception and offering a “win-win” outcome for all participating parties, the Rayr-Mobile App saves its “buyers” money while generating its “sellers” income. The Rayr-Mobile App is cost-effective to produce in the embodiments, as shown in FIGS. 1-13.

Referring to the drawings by numerals of reference there is shown in FIGS. 1-13, the Rayr-Mobile App 4 comprising a novel product offering consumers a practical solution to the aforementioned challenges. As the name implies, the Rayr-Mobile App 4 brings “buyers” and “sellers” together over their smartphones, the “buyers” renting tools, equipment, sporting goods—almost anything they might need on a limited basis—from the “sellers”.

FIG. 1 shows at least one computer member 1, in this case a smart phone, which includes a housing 2 having an interior volume with computer circuitry located therein. The computer member 1 further has at least one input member 6 in the form of a touch screen located on an outer surface 3 thereof which enables a user to input information into the computer circuitry. The computer member 1 is formed as either a smart phone or a laptop computer.

The computer member 1 further has an output screen 7 located on the outer surface 3 of the housing 2 which allows a user to view information from the computer circuitry. Software application is encoded onto the computer circuitry and provides a first input screen 9 which is viewed on the output screen 7 and provides a welcoming screen, providing an explanation of the features of the application.

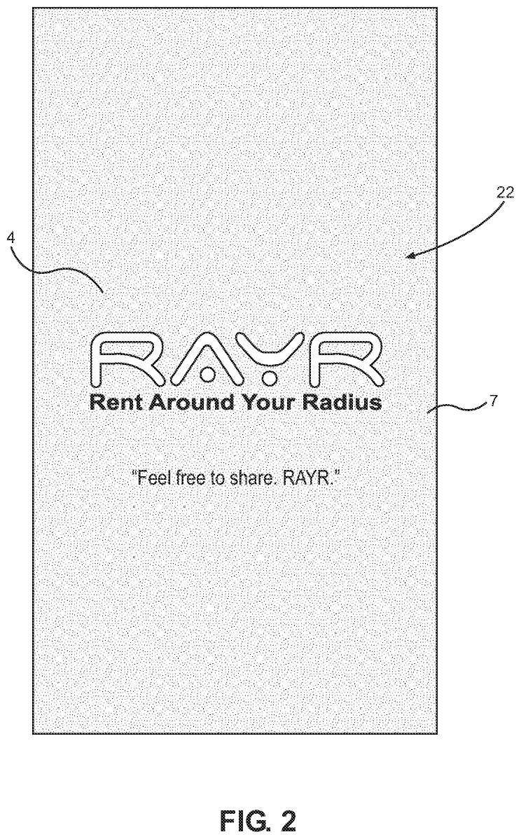

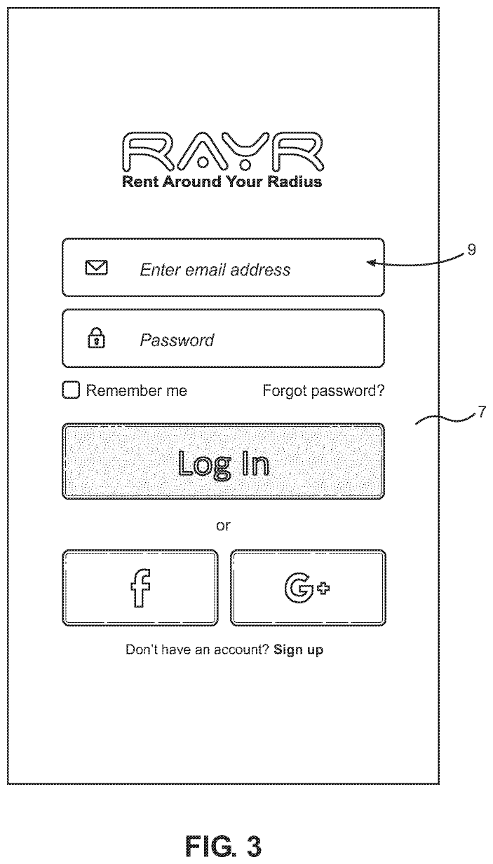

The Rayr-Mobile App 4 functions somewhat in the manner of Craigslist—as a localized clearinghouse in which those looking to rent something, and those looking to rent something out, are brought together. The splash screen 22 of the app as seen in FIG. 2, features a welcoming Rayr-Mobile App logo, followed by a simple explanation of the app's features. The first input screen 9 as shown in FIG. 3 is a log-in screen wherein a user accesses the app. Different means to log-in are provided such as logging in with Facebook or Google.

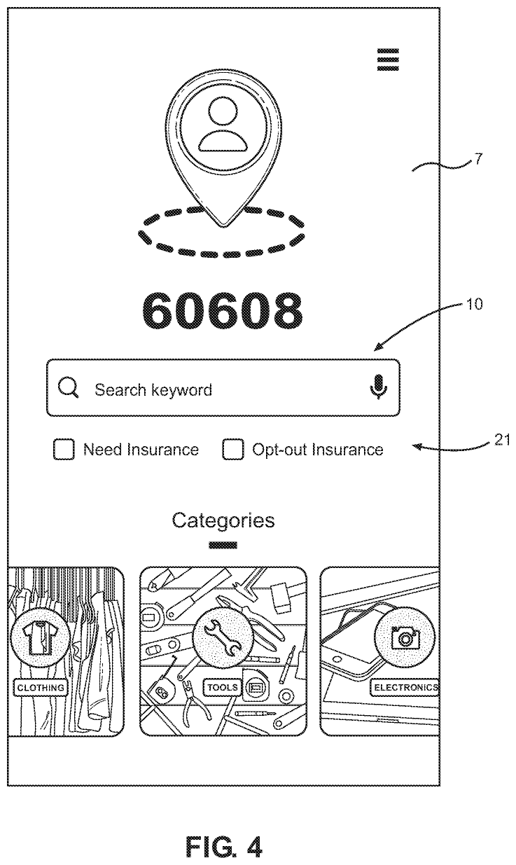

The user is directed to a Search page 10 in FIG. 4, in which the user enters the articles desired—a pressure-washer, perhaps, or automotive tools, or camping equipment. The software application allows a deposit to be placed on items rented and to further allow insurance 21 to be bought to protect the two parties if damage occurs to the articles being rented.

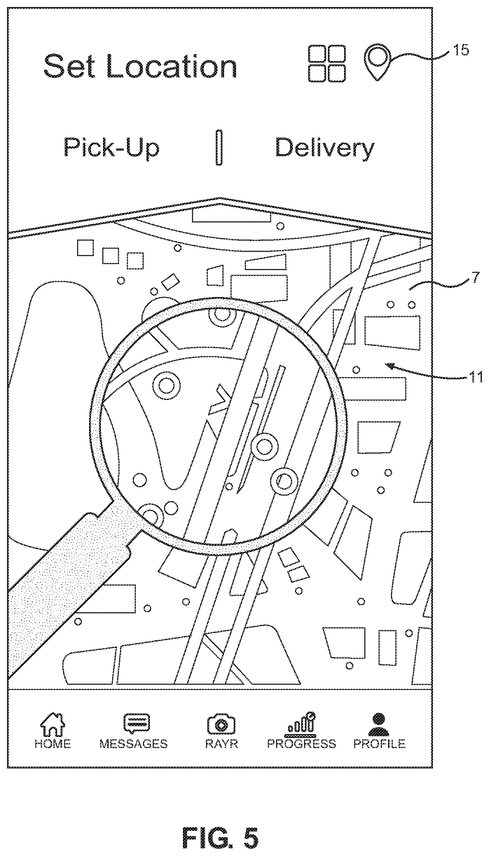

As seen in FIG. 5, a user enters their current location 15 and a search radius 11 with respect to their current location 15 in miles, searching all listings within five miles, 10 miles, 25 miles, and so forth. At this point, the app produces all listings for the desired articles, and permits the user to contact the “seller” to arrange the details. The option of pick-up or delivery is given.

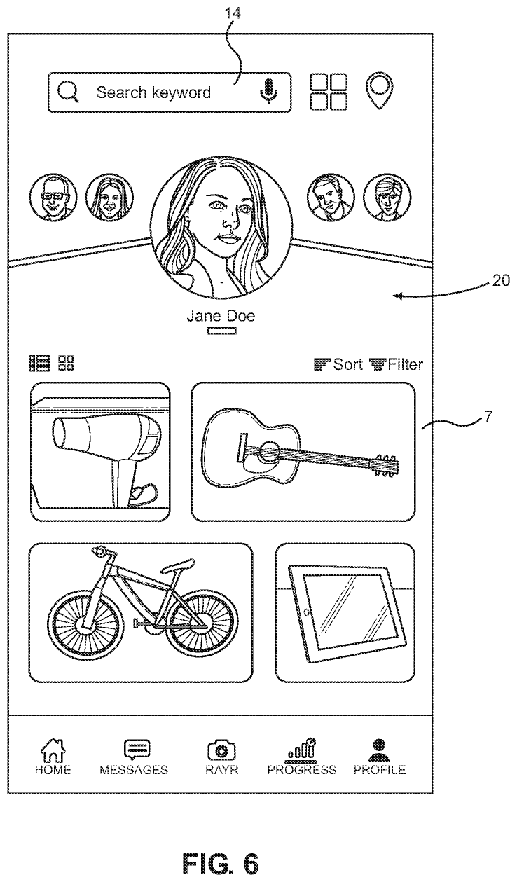

The software application also provides a membership page 20 as seen on FIG. 6 which is adapted to be viewed upon the output screen 7 which allows a user to become a member. Membership is offered on multi-tiered basis having levels which include free membership, master membership and a platinum membership. The app lists the article(s) for rent, with a description 14, as seen in FIG. 5.

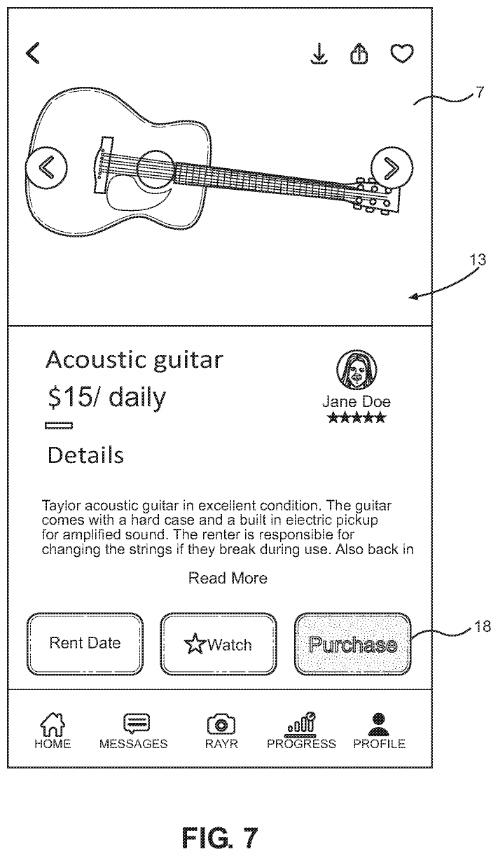

A results page 13 as shown in FIG. 7 is provided by the software application which lists the match results thereon and provides contact information of the owner of each respective article listed such that a user is able to contact the owner for the renting of the article. The results page 13 provides a map of the location of the user 15 and the match results within the search radius 11 specified.

The app also functions for the transfer of funds 18 as shown in FIG. 7. Once a transaction has been agreed upon and completed, the user can rate the transaction, and rate the “seller,” on a five-star rating system. The Rayr-Mobile App 4 offers membership on a multi-tiered basis, with levels including a “no-frills” Free membership, a Master membership, or a Platinum membership, each of which offers certain services and conveniences. Further, the Rayr-Mobile App 4 is constructed such that a renter puts a deposit on items rented, and pays insurance 21 on them—a feature that is desirable in the view of those renting-out articles and equipment. The software application also allows for the transfer of funds 18 as seen in FIG. 7 between two parties.

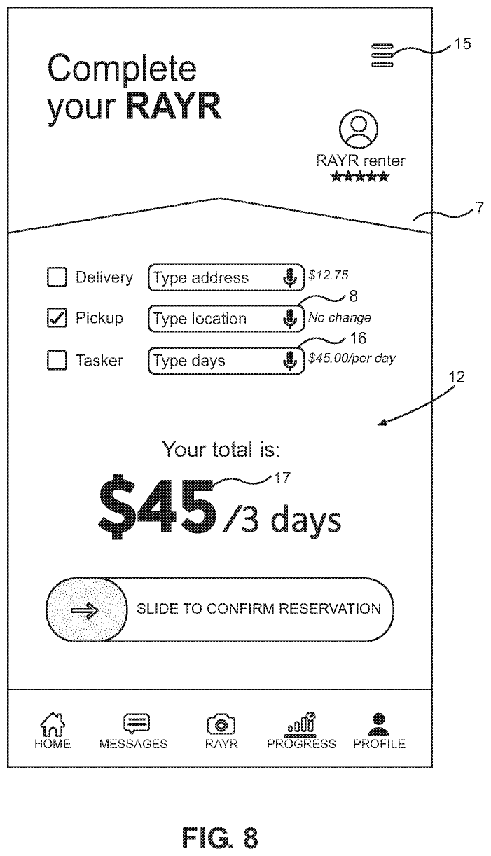

An article data base input screen 12 as seen in FIG. 8 allows articles available to be rented to be input and thereby form the data base of articles available. The article data base screen 12 shows a user the location 8 of the items to be rented and the location of the users 15 and the rental periods 16 available and the prices 17 for the rental.

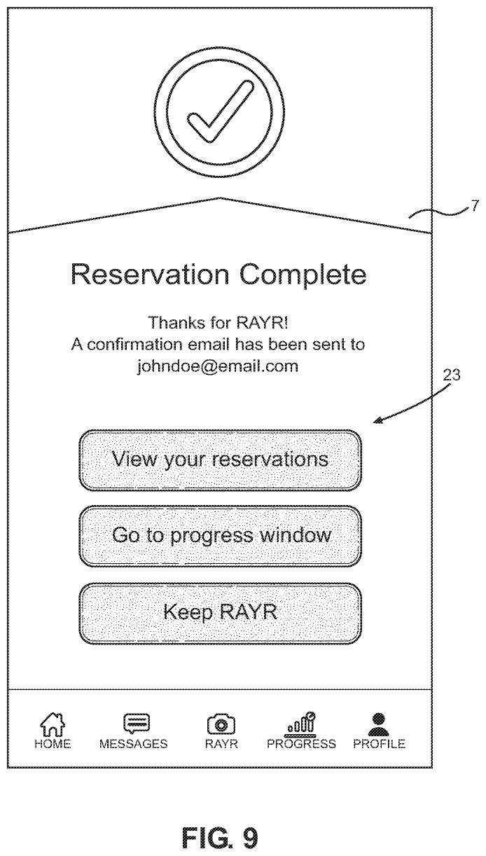

FIG. 9 shows the reservation complete page on the output screen 7 wherein a user can view their reservation and go to a progress window. The user can also view their reservations. The user is thanked for using the app and states that a confirmation email has been sent to the user's email.

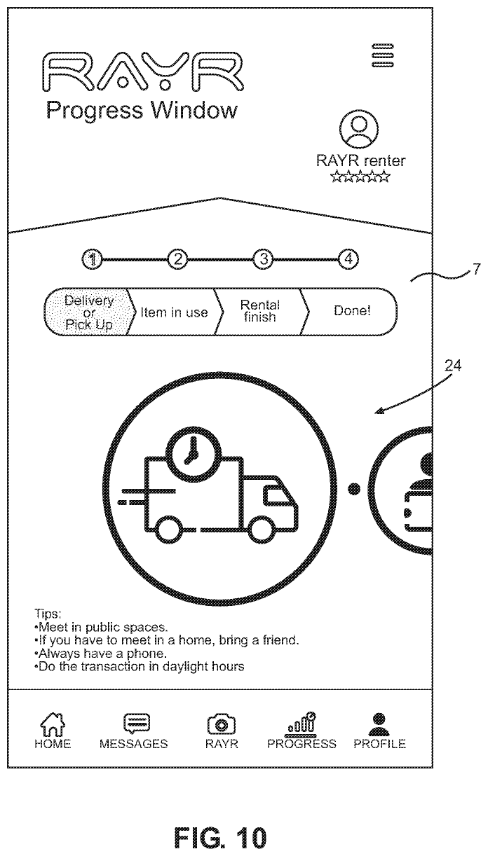

FIG. 10 shows a delivery or pick-up page 24 and shows the progression to the items in use page which follows. A red truck surrounded by a circle is shown.

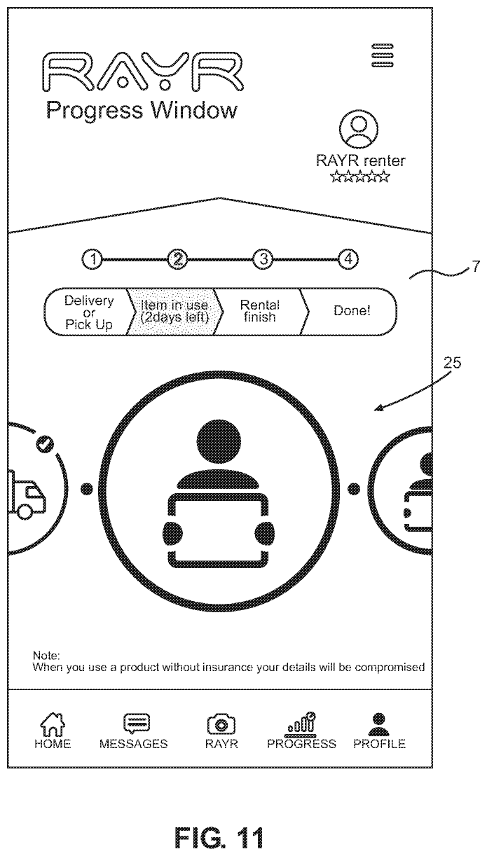

FIG. 11 shows Item in use page 25 which reveals how many days the renter has left. A person holding an item in yellow surrounded by a circle is shown.

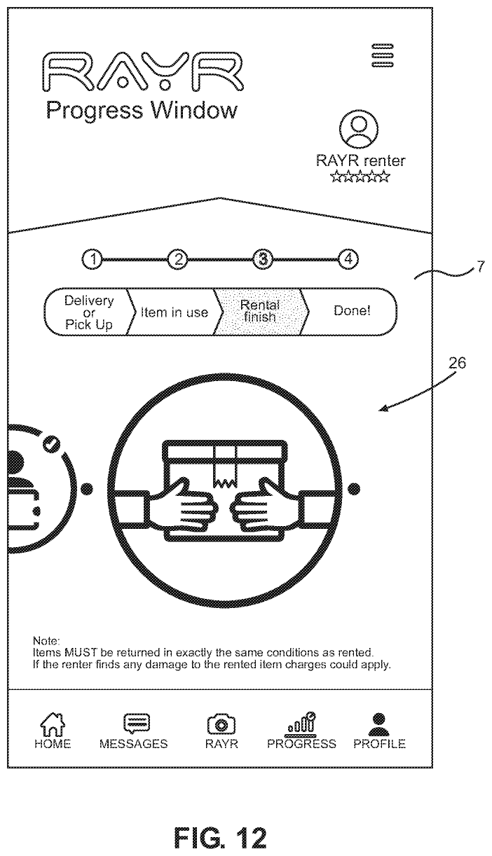

FIG. 12 shows a Rental Finish page 26. A green box being handed between two parties is depicted surrounded by a circle.

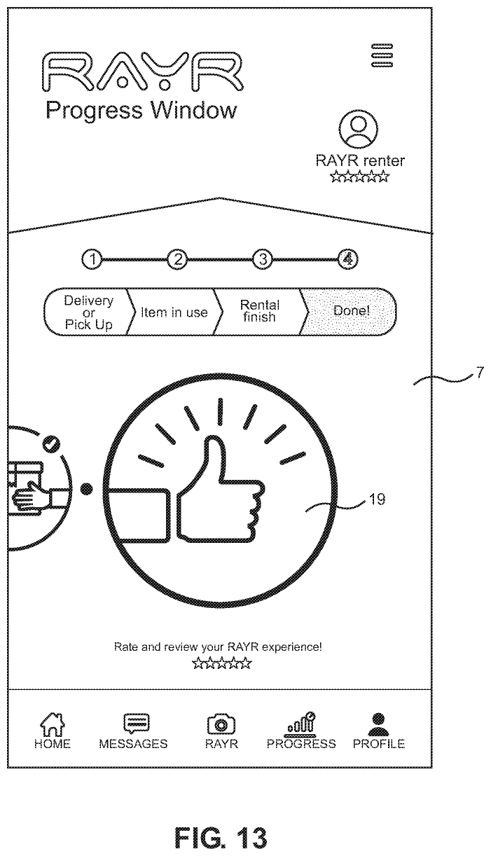

The software application also allows a user to rate a rental transaction and rate a renter using a five-star rating system by providing a ratings page 19 as shown in FIG. 13 which ratings are then published so as to be viewed by other users. A thumbs up in blue surrounded by a circle is shown.

Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A method of renting between two parties, said method comprising the steps of:
providing at least one computer member including:
a housing;
wherein said housing forms an interior volume;
computer circuitry;
wherein said computer circuitry is located within said interior volume; and
at least one input member;
wherein said at least one input member is located on an outer surface of said housing and is adapted to allow a user to input information into said computer circuitry; and
an output screen;
wherein said output screen is located on an outer surface of said housing and is adapted to allow a user to view information from said computer circuitry; and
providing a software application:
wherein said software application is encoded onto said computer circuitry;
and
wherein said software application is adapted to:
provide a first input screen adapted to be viewed upon said output screen;
wherein said first input screen is formed as a welcoming screen and provides an explanation of the applications features;
providing a search page adapted to be viewed upon said output screen;
wherein said search page is adapted to follow said first input screen;
allow a user to enter a description of an article to be rented;
allow a user to enter their current location;
allow a user to enter a search radius with respect to said current location;
access a data base of articles available to be rented and their location;
compare said articles available and their location to said article to be rented with said search radius and determine match results therebetween;
provide a results page adapted to be viewed upon said output screen;
wherein said results page is adapted to list said match results thereon; and
wherein said results page is adapted to provide contact information of the owner of each respective article listed as a match result, such that said user is able to contact said owner for renting said article.

2. The method of claim 1, wherein said software application is further adapted to provide a second input screen adapted to be viewed upon said output screen and formed as an article data base input screen adapted to allow articles available to be rented to be inputted thereto and form said data base of articles available.

3. The method of claim 2, wherein said article data base input screen is further adapted to allow a user to enter a description of an article to be rented.

4. The method of claim 3, wherein said article data base input screen is further adapted to allow a user to enter their current location.

5. The method of claim 4, wherein said article data base input screen is further adapted to allow a user to enter rental periods available.

6. The method of claim 4, wherein said article data base input screen is further adapted to allow a user to enter rental prices.

7. The method of claim 1, wherein said software application is further adapted to allow for the transfer of funds between said two parties.

8. The method of claim 1, wherein said software application is further adapted to allow a user to rate a rental transaction and rate a renter using a five-star rating system; and wherein said software application is further adapted to provide a ratings page adapted to be viewed upon said output screen and adapted to publish ratings to be viewed by other users.

9. The method of claim 1, wherein said software application is further adapted to provide a membership page adapted to be viewed upon said output screen, and adapted to allow a user to become a member.

10. The method of claim 1, wherein said membership page is further adapted to offer memberships on a multi-tiered basis having levels including a free membership, a master membership, and a platinum membership.

11. The method of claim 1, wherein said software application is further adapted to allow a deposit to be placed upon items rented.

12. The method of claim 1, wherein said software application is further adapted to allow insurance to be bought to protect the two parties if damage occurs to articles being rented.

13. The method of claim 1, wherein said results page is further adapted to provide a map of the location of said user and said matches within said search radius.

14. The method of claim 1, wherein said at least one computer member is formed as a smart phone.

15. The method of claim 1, wherein said at least one computer member is formed as a laptop computer.
